(19) United States
(12) Patent Application Publication
(10) Pub. No.: US 2025/0217806 A1
(43) Pub. Date: Jul. 3, 2025

(54) OCCASION-BASED PROXY TRANSACTION ACCOUNT GROUPS

(71) Applicant: American Express Travel Related Services Company, Inc., New York, NY (US)

(72) Inventors: SIVA KUMAR EDUPUGANTI, Phoenix, AZ (US); ANIL B. KELWALKAR, Phoenix, AZ (US); YOGARA JAYAPRAKASAM, Phoenix, AZ (US)

(21) Appl. No.: 19/087,961

(22) Filed: Mar. 24, 2025

Related U.S. Application Data
(63) Continuation of application No. 17/520,978, filed on Nov. 8, 2021.

(51) Int. Cl. G06Q 20/40; G06Q 20/06; G06Q 20/22

(52) U.S. Cl. CPC G06Q 20/4014; G06Q 20/065; G06Q 20/229; G06Q 20/405

(57) ABSTRACT

Disclosed are various embodiments for creating a proxy transaction account for a group of members (e.g., consumers) to use when sharing occasion-based expenses (e.g., trip expense, party expenses, etc.). In various examples, a proxy transaction account for a group of members can be created and a payment instrument (e.g., a physical or virtual payment card) associated with the proxy transaction account can be presented to a merchant to pay for the goods or services associated with a transaction. According to various examples, the transaction amount for the transaction can be split and the respective split amount can be applied to each member payment account of the group of members or the transaction amount can be applied to one or more selected member payment account(s) of the group of members in order to maximize reward offers associated with the transaction.

### CROSS-REFERENCE TO RELATED APPLICATIONS

This application is a continuation of, and claims priority to and the benefit of, co-pending U.S. patent application Ser. No. 17/520,978, titled “OCCASION-BASED PROXY TRANSACTION ACCOUNT GROUPS” and filed on Nov. 8, 2021, which is incorporated by reference as if set forth herein in its entirety.

### BACKGROUND

When a consumer engages in a transaction with a provider of goods or services, the consumer can use a payment instrument (e.g., a transaction card such as a credit or debit card) that is associated with a payment issuing service (e.g., issuer) to pay for the goods or services associated with the transaction. In this case, the consumer has entered into an agreement with the issuer such that the issuer agrees to pay the merchant on behalf of the user. Typically, in these situations, the merchant utilizes a transaction terminal or point-of-sale device that determines whether a consumer's payment instrument is authorized to enter into the transaction, and the issuer pays the provider for the outstanding balance associated with the transaction.

In some situations, a group of consumers share multiple expenses (e.g., lodging, meals, gas, etc.) associated with an occasion (e.g., trip, party, etc.). In these situations, one consumer can use their payment instrument for all expenses or different consumers can randomly use their respective payment instruments for different expenses. However, this process can have various disadvantages that can be burdensome to the consumers and create potential security risks. For example, one disadvantage is that the consumers will need to go through the tedious process of splitting the bills during or at the completion of the occasion. In addition, consumers may unintentionally use a payment instrument that fails to maximize rewards. Further, using a payment instrument at a new place can be insecure and consumer information associated with the payment instrument being used may be unintentionally shared. Another disadvantage is that the consumers may be unable to view a full list of transactions associated with the occasion since the expenses may be spread across multiple payment instruments.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting one of several embodiments of the present disclosure.

FIG. 2 is a drawing of a network environment according to various embodiments of the present disclosure.

FIGS. 3A-3E are a pictorial diagrams of example user interfaces rendered by a client device in the network environment of FIG. 2 according to various embodiments of the present disclosure.

FIG. 4 is a flowchart illustrating one example of functionality implemented as portions of a proxy account management service executed in a computing environment in the network environment of FIG. 2 according to various embodiments of the present disclosure.

FIG. 5 is a flowchart illustrating one example of functionality implemented as portions of an issuer service executed in a computing environment in the network environment of FIG. 2 according to various embodiments of the present disclosure.

FIG. 6 is a flowchart illustrating one example of functionality implemented as portions of the issuer service executed in a computing environment in the network environment of FIG. 2 according to various embodiments of the present disclosure.

FIG. 7 is a flowchart illustrating one example of functionality implemented as portions of the issuer service executed in a computing environment in the network environment of FIG. 2 according to various embodiments of the present disclosure.

### DETAILED DESCRIPTION

Disclosed are various approaches for creating a proxy transaction account for a group of members (e.g., consumers) to use when sharing occasion-based expenses (e.g., trip expense, party expenses, etc.). In various examples, a proxy transaction account for a group of members can be created. A payment instrument (e.g., a physical or virtual payment card) associated with the proxy transaction account can then be presented to a merchant to pay for the goods or services associated with a transaction. According to various examples, the transaction amount for the transaction can be split and the respective split amount can be applied to each group member's payment account or the transaction amount can be applied to a select member payment account(s) of the group of members in order to maximize reward offers associated with the transaction.

For example, in various situations, a group of consumers can share expenses (e.g., lodging, meals, gas, etc.) associated with a given event or occasion (e.g., trip, party). Typically, one consumer uses their payment instrument for all expenses or different consumers use their respective payment instruments for different expenses. Once the expenses are incurred, the individuals of the group typically reconcile the amount owed to one other. This process can be cumbersome, unintentionally result in reward offers being missed, and can be potentially insecure for the individuals who use their payment instruments to pay for the expenses. In addition, there can risks associated with fraud and failure to pay among group members which can result in negative experiences for the other group members. According to various embodiments, the present disclosure improves on the overall customer experience associated with expense sharing with multiple users by providing an automated transaction management system that manages the expense splitting among the group member's accounts for each transaction, automatically identifies and selects payment instruments associated with the group members to apply to various transactions in order to maximize reward offers, and preserves the privacy of the consumer(s) by keeping their respective data private and reducing the risk of fraud or failure to pay.

According to various embodiments of the present disclosure, a proxy transaction account (e.g., a payment account) can be created that is associated with multiple transaction accounts associated with a user or a group of users. For example, a user can request the creation of a proxy transaction account for a given occasion (e.g., a trip, party, etc.). When requesting the creation of a proxy transaction account, the user can provide his or her own member transaction account data for a payment account that is to be used for occasion-based expenses and identify one or more members (e.g., persons going on trip with creator) to invite to the group associated with the proxy transaction account. In some examples, a user having multiple payment accounts may create a proxy transaction account for only themselves where the proxy transaction account is associated with the multiple payment accounts of the user.

When the proxy transaction account is created for a group of members, an invitation to join the proxy transaction account group is sent to each of the identified members. When a member accepts the invitation to join the proxy transaction group, the member provides his or her respective member payment account data for his or her payment account that is to be used for occasion-based expenses. According to various examples, member payment account data includes payment instrument data defining a payment account number, a cardholder name, an expiration date, a verification code, a billing address, and/or other information needed to consummate a payment.

According to various examples, when at least one invited member accepts the invitation to join the proxy transaction group, a proxy transaction account is created and the proxy transaction group comprises the lead member and any invited member who has accepted the invitation to join. The proxy transaction account can include a proxy transaction account number which can be provided to a client device associated with the proxy transaction group creator (e.g., the lead member) and/or another invited member who has accepted the invitation to join for storage in a digital wallet (e.g., GOOGLE PAY®, APPLE PAY®) for immediate and future use. In some examples, a physical payment instrument (e.g., credit card) associated with the proxy transaction account can be generated and mailed to the lead member and/or any invited and accepted member. In other examples, one or more members 121 may be provided a payment account number, a cardholder name, an expiration date, a verification code, a billing address, and/or other information needed to consummate a payment. This information can be provided to the members 121 electronically, over the phone, and/or through the mail.

In various examples, group rules can be defined that are applied to transactions associated with the group. For example, the creator (e.g., the lead member) of the proxy transaction group can define the one or more group rules when creating the proxy transaction account group. The group rules can include an indication as to whether a transaction amount of a transaction is to be split among all of the member payment accounts (e.g., equally or according to a predefined ratio) or whether priority should be given to one or more member payment accounts having a reward offer corresponding to the given transaction. In addition, the group rules can include an expiration date associated with the proxy transaction account (e.g., an end date of the event), a maximum transaction amount for all transactions, a maximum amount for individual transactions, permitted merchants, excluded merchants, permitted merchant types (e.g., restaurants, airlines, hotels, etc.), permitted merchant locations, and/or other types of rules.

In addition, it should be noted that the proxy transaction account group is not a static group. In particular, members can be added or removed to the proxy transaction account group while the group and corresponding transaction account remains active (e.g., prior to the expiration of the proxy transaction group or end of occasion/event). In various examples, the lead member can request for one or more members to be removed. In other examples, an invited member can request to be removed from the group. In some examples, when a user is removed from the group, the corresponding member payment account is also removed and the transaction amount is not applied to the removed member's payment account.

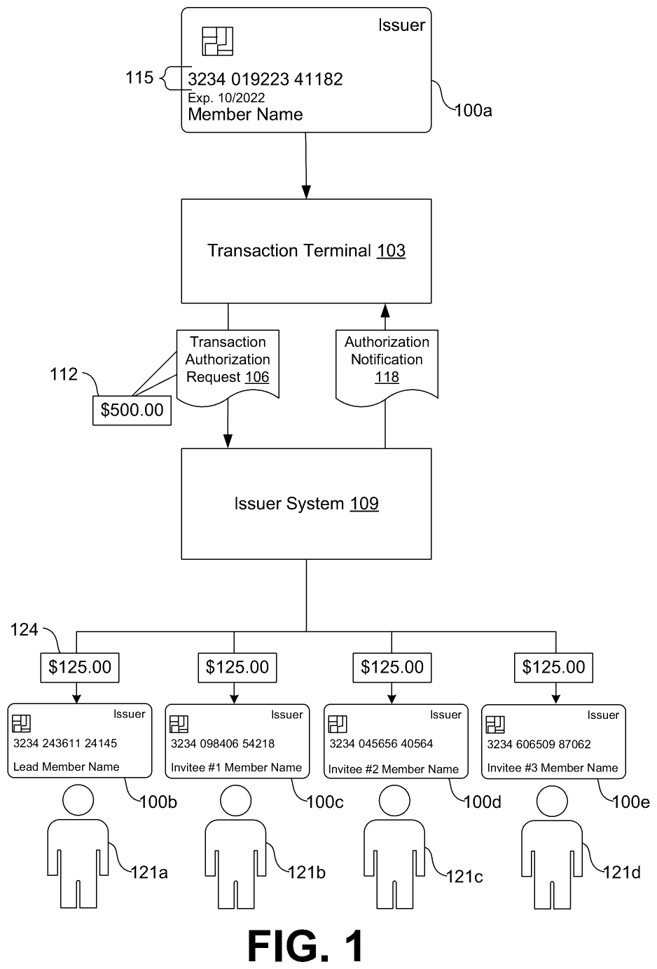

As illustrated in FIG. 1, the interaction between a merchant and an issuer is unchanged from traditional methods when a payment instrument 100a associated with the proxy transaction account is presented at a transaction terminal 103 during a transaction for goods or services provided by a merchant. For example, when a payment instrument 100 associated with the proxy transaction account is presented to a transaction terminal 103 for the purchase of goods or services, the transaction terminal 103 generates and sends a transaction authorization request 106 to an issuer system 109 associated with the payment instrument 100. The transaction authorization request 106 can comprise a transaction amount 112, payment instrument data (e.g., an account number 115, an account name, a verification code, etc.), a merchant identifier, and/or other type of transaction data. If the transaction is authorized by the issuer system 109, the issuer system 109 sends an authorization notification 118 to the transaction terminal 103 or associated merchant system indicating that the transaction is authorized. Otherwise, the issuer system 109 sends an authorization notification 118 to the transaction terminal 103 or associated merchant system indicating that the transaction authorization request 106 is denied.

In accordance to various examples, upon receiving the transaction authorization request 106 including the payment instrument data identifying a proxy transaction account, the issuer system 109 determines whether the transaction is valid according to the predefined group rules. For example, the issuer system 109 can determine that the transaction amount 112 is within an approved budget associated with the proxy transaction group. Further, the issuer system 109 can confirm that funds or credit are available for the payment instruments 100 of the member payment accounts that are mapped to the proxy transaction account. In response to determining that the transaction is valid, the issuer system 109 approves or otherwise authorizes the transaction.

According to various examples, the issuer system 109 determines whether the transaction amount 112 is to be split among the respective member payment accounts associated with payment instruments 100 (e.g., 100b, 100c, 100d, 100e) of the individual group members 121 (e.g., 121a, 121b, 121c, 121d) or if reward offers associated with the payment instruments 100 are to be maximized. According to various examples, the issuer system 109 can analyze the corresponding rules which define how the transaction amount is to be applied to the member transaction accounts of the group. In the example depicted in FIG. 1, the transaction amount 112 of $500 would be split equally among the respective member payment accounts, such that a respective split amount 124 (e.g., $125) of the transaction amount 112 is applied to the respective member payment accounts corresponding to the payment instruments of each member 121 in the group.

In some examples, the transaction amount 112 is not split among the group member's payment accounts. In this example, the issuer system 109 can apply or otherwise deduct the transaction amount 112 from a particular payment account corresponding to one of the group members 121 based at least in part on available reward offers associated with the particular payment account. As such, the transaction amount 112 can be applied to only the selected payment account to maximize the reward offers and benefits associated with the group member's respective payment instruments 100. In various examples, the issuer system 109 can track the expenses associated with the different transactions for a unified summary of the transactions and transaction amounts applied to each member payment account. In various examples, the unified summary can be presented to the group members via a user interface to allow the group members to review.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

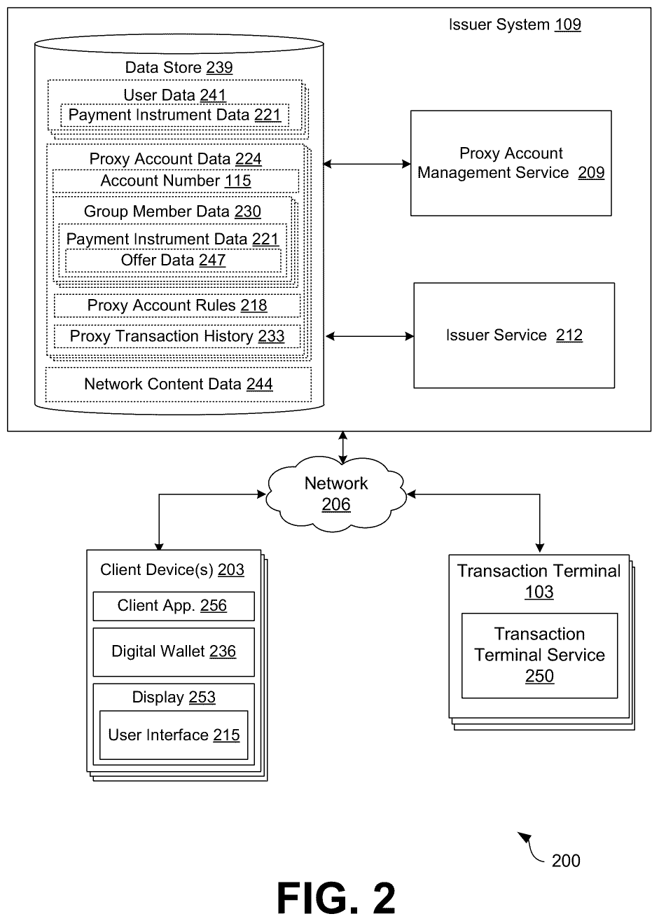

With reference to FIG. 2, shown is a network environment 200 according to various embodiments. The network environment 200 can include an issuer system 109, a transaction terminal 103, and a client device 203, which can be in data communication with each other via a network 206. The network 206 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 206 can also include a combination of two or more networks 206. Examples of networks 206 can include the Internet, intranets, extranets, virtual private networks (VPNs), and similar networks.

The issuer system 109 can comprise, for example, a server computer or any other system providing computing capability. Alternatively, the issuer system 109 can employ a plurality of computing devices that can be arranged, for example, in one or more server banks or computer banks or other arrangements. Such computing devices can be located in a single installation or may be distributed among many different geographical locations. For example, the issuer system 109 can include a plurality of computing devices that together can comprise a hosted computing resource, a grid computing resource, and/or any other distributed computing arrangement. In some cases, the issuer system 109 can correspond to an elastic computing resource where the allotted capacity of processing, network, storage, or other computing-related resources can vary over time.

Various applications and/or other functionality can be executed in the issuer system 109. The components executed on the issuer system 109, for example, include a proxy account management service 209, an issuer service 212, and other applications, services, processes, systems, engines, or functionality not discussed in detail herein. The proxy account management service 209 can be executed to facilitate the creation and management of group proxy transaction accounts. For example, the proxy account management service 209 can generate one or more user interfaces 215 for rendering on a client device 203 associated with a user. In various examples, the one or more user interfaces 215 can be rendered on the client device 203 to allow a user to request the creation of a group proxy transaction account and define both the members 121 (FIG. 1) of the group proxy transaction account and the proxy account rules 218 that are used to manage the operation of the proxy transaction account. For example, a user can define the members 121 of the group by providing member contact data (e.g., email address, phone number, etc.) that can be used to contact the respective members 121 when inviting the members 121 to participate in the group.

According to various examples, the proxy account management service 209 generates and sends invitations to the members 121 identified by the lead member 121 requesting creation of a group. In various examples, the invitation can include a link to access one or more user interfaces 215 generated by the proxy account management service 209 to provide the invited member 121 the ability to register with the proxy account management service 209 and/or input his or her member payment account data, including payment instrument data 221. The payment instrument data 221 can correspond to data associated with payment accounts provided by an issuer associated with of the issuer system 109 or another issuer. For example, the payment instrument data 221 can comprise data describing credit card accounts, debit card accounts, virtual cards, charge card accounts, and/or other mechanisms for effecting a payment with respect to a transaction account provided by the issuer of the issuer system 109 and associated with the user of the client device 203 or the user interacting with a transaction terminal 103. For example, for a credit card account or a charge card account, the payment instrument data 221 can store a card number, a cardholder name, an expiration date, a verification code, a billing address, and/or other information needed to consummate a payment.

In response to receiving an acceptance from at least one member 121 of the invited members, the proxy account management service 209 generates a proxy transaction account. In particular, the proxy account management service 209 can generate proxy account data 224 that is associated with a particular proxy group created via the proxy account management service 209. The proxy account data 224 can include a group name, a group lead member identifier, an account number 115, group member data 230, proxy account rules 218, proxy transaction history 233, and/or other data.

The proxy account management service 209 can send the account number 115, an expiration date, a proxy account address, a proxy account name, a verification code, and/or other data to a client device 203 associated with one or more members 121 of the group for storage in a digital wallet 236. In various examples, the proxy account management service 209 can initiate a creation of and mailing of a physical payment card for the proxy transaction account. In various examples, the physical payment card is mailed to an address of the lead member 121 of the group and/or other members 121 of the group. In other examples, one or more members 121 may be provided a payment account number, a cardholder name, an expiration date, a verification code, a billing address, and/or other information needed to consummate a payment. This information can be provided to the members 121 electronically, over the phone, and/or through the mail.

In various examples, the proxy account management service 209 can facilitate the review of proxy transaction history 233 via a user interface 215. The proxy transaction history 233 represents data associated with the proxy transaction account that have been previously authorized. In some examples, the proxy transaction history 233 includes a proxy transaction table that identifies the transactions associated with the proxy transaction account and the respective split amount 124 applied to the member payment account of the user interacting with the proxy account management service 209. Accordingly, the user is able to review all transactions applied to his or her member payment account with respect to transactions made using the proxy transaction account.

The issuer service 212 can be executed to provision transaction terminals 103 to accept payments using payment instruments 100 issued by the issuer service 212. The issuer service 212 can receive pending transaction data in a transaction authorization request 106 for a given transaction from the transaction terminal 103. Using the pending transaction data included in a transaction authorization request 106, the issuer service 212 can confirm that funds or credit are available for a given payment instrument, such that the payment transaction is authorized to proceed or not authorized to proceed. In examples where the transaction data indicates that the payment instrument 100 corresponds to a proxy transaction account, the issuer service 212 can confirm that funds or credit are available for the payment instruments 100 of the member payment accounts that are mapped to the proxy transaction account to determine whether the payment transaction account is authorized to proceed or not authorized to proceed.

In various examples, the issuer service 212 can analyze the proxy account rules 218 with respect to the transaction data to determine whether the transaction is a valid transaction for the proxy transaction group. For example, the proxy account rules 218 can indicate a maximum amount of funds to be charged with a given transaction and/or over all transactions. If the transaction amount 112 included in the transaction data exceeds the maximum amount of funds defined by the proxy account rules, 218, the issuer service 212 can deny the transaction authorization request 106 received from the transaction terminal 103.

Further, the issuer service 212 can perform its own risk analysis to determine whether to authorize or deny the payment transaction. For example, the issuer service 212 can invoke a fraud detection service to predict whether the pending transaction is fraudulent. Upon authorization of the transaction, the issuer service 212 can generate and send an authorization notification 118 to the transaction terminal 103 indicating that the transaction authorization request 106 is approved. If the transaction is predicted to be fraudulent, the issuer service 212 can send an authorization notification 118 to the transaction terminal service 250 indicating that the transaction is denied.

Also, various data is stored in a data store 239 that is accessible to the issuer system 109. The data store 239 can be representative of a plurality of data stores 239, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 239 is associated with the operation of the various applications or functional entities described below. This data can include user data 241, proxy account data 224, network content data 244 and potentially other data.

The user data 241 corresponds to information related to individuals who have been issued payment accounts by an issuer associated with the issuer system 109. A payment account can represent any financial account or agreement that a customer can use as a source of funds for payments. Payment accounts can include both credit accounts or facilities and financial deposit accounts that provide the owner with on demand access to funds stored in or associated with the payment account. In some instances, a payment account can allow a user to have frequent and/or immediate access to funds. In these instances, payment accounts can also be referred to as demand deposit accounts, which can be accessed in a variety of ways, such as the use of debit cards, checks, or electronic transfers (e.g., wire transfer, automated clearing house (ACH) transfer, etc.). Examples of payment accounts include charge or charge card accounts, credit or credit card accounts, checking accounts, savings accounts, money market accounts, demand accounts, deposit accounts, demand deposit accounts, etc.

The user data 241 can include payment instrument data 221, transaction history data, account address(es), account holder name(s), account holder contact information, authentication information, and/or other data associated with a user or user account provided by the issuer. The payment instrument data 221 can correspond to data associated with payment accounts provided by an issuer associated with of the issuer system 109. For example, the payment instrument data 221 can comprise data describing credit card accounts, debit card accounts, virtual cards, charge card accounts, and/or other mechanisms for effecting a payment with respect to a transaction account provided by the issuer of the issuer system 109. For example, for a credit card account or a charge card account, the payment instrument data 221 can store a card number, a cardholder name, an expiration date, a verification code, a billing address, and/or other information needed to consummate a payment.

The proxy account data 224 can represent the data associated with a given proxy account group. The proxy account data 224 can include an account number 115, group member data 230, proxy account rules 218, proxy transaction history 233, a proxy group name, a proxy group creator identifier, and/or other data. The account number 115 corresponds to an issuer assigned account number to represent a given proxy transaction account. The issuer assigned account number is a unique number that is used to identify an issuer associated with the account and a payment account provided by the issuer. The group member data 230 corresponds to the information related to members 121 included in a given proxy transaction account group for a given proxy transaction account. The group member data 230 includes information related to the lead member 121 as well as to any invited members 121 who have accepted the invitation to join the group.

In various examples, each member 121 identified in the group member data 230 has a respective payment account (e.g., member transaction account) that represents any financial account or agreement that a customer can use as a source of funds for payments. Payment accounts can include both credit accounts or facilities and financial deposit accounts that provide the owner with on demand access to funds stored in or associated with the payment account. In some instances, a payment account can allow a user to have frequent and/or immediate access to funds. In these instances, payment accounts can also be referred to as demand deposit accounts, which can be accessed in a variety of ways, such as the use of debit cards, checks, or electronic transfers (e.g., wire transfer, automated clearing house (ACH) transfer, etc.). Examples of payment accounts include charge or charge card accounts, credit or credit card accounts, checking accounts, savings accounts, money market accounts, demand accounts, deposit accounts, demand deposit accounts, etc.

The group member data 230 can include payment instrument data 221, account address(es), account holder name, account holder contact information, authentication information, and/or other data associated with a user or user account provided by an issuer. The payment instrument data 221 can correspond to data associated with payment accounts provided by an issuer associated with of the issuer system 109. For example, the payment instrument data 221 can comprise data describing credit card accounts, debit card accounts, virtual cards, charge card accounts, and/or other mechanisms for effecting a payment with respect to a transaction account provided by the issuer of the issuer system 109 or another issuer. For example, for a credit card account or a charge card account, the payment instrument data 221 can store a card number, a cardholder name, an expiration date, a verification code, a billing address, and/or other information needed to consummate a payment.

In various examples, the payment instrument data 221 can further include offer data 247. The offer data 247 can identify one or more offers that can be earned by using the respective payment instrument 100 for a given transaction. The one or more offers can include an award of loyalty points, a rebate amount, a discount for the items being purchased, a reward currency, a loyalty currency, and/or the like. In various examples, each offer can have offer criteria which defines various factors that must be met in order for the respective offer to be earned. For example, the offer criteria can define a merchant, a merchant type, a transaction amount, a type of transaction (e.g., online vs. brick and mortar), a location of the transaction, a time or date associated with the transaction and/or other factors that may need to be met for a given transaction in order to earn the respective offer and/or reward.

The proxy account rules 218 define rules that are to be applied to transactions associated with the group. For example, the creator (e.g., the lead member 121) of the proxy transaction group can define the proxy account rules 218 when creating the proxy transaction account group. The proxy account rules 218 can include an indication as to whether a transaction amount of a transaction is to be split among all of the member payment accounts (e.g., equally or according to a predefined ratio) or whether priority should be given to one or more member payment accounts having a reward offer corresponding to the given transaction. In addition, the proxy account rules 218 can include an expiration date associated with the proxy transaction account (e.g., an end date of the event), a maximum transaction amount for all transactions, a maximum amount for individual transactions, permitted merchants, excluded merchants, permitted merchant types (e.g., restaurants, airlines, hotels etc.), permitted merchant locations, and/or other types of rules.

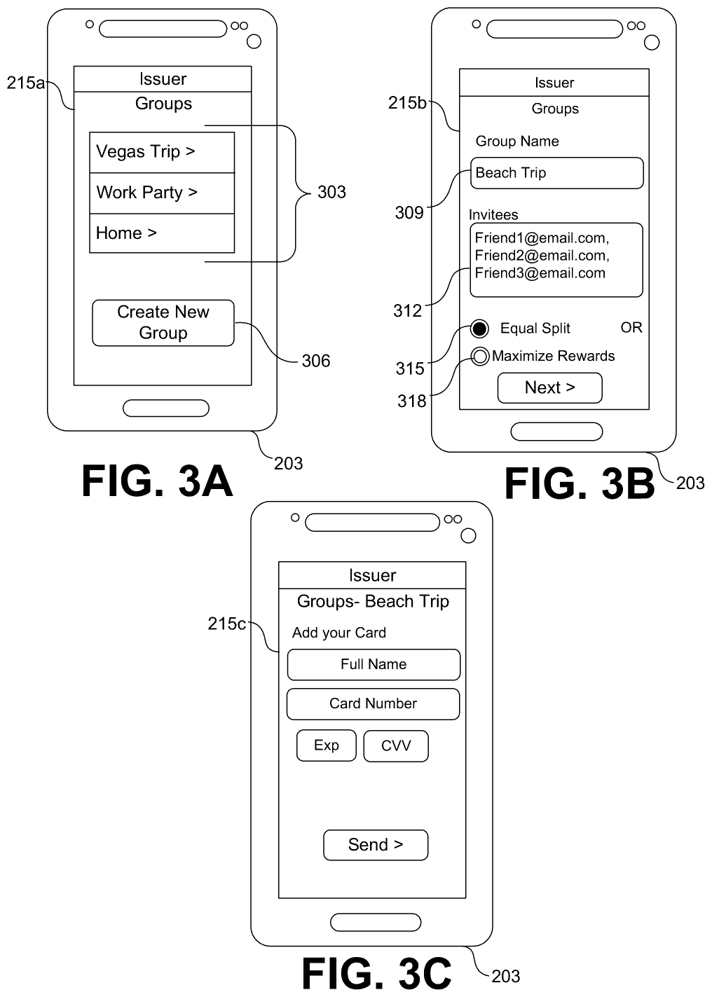

The proxy transaction history 233 includes transaction data associated with prior transactions using the particular proxy transaction account. The proxy transaction history 233 can include a transaction amount 112, a transaction merchant, industry identification data associated with the transaction (e.g., fast food restaurant, hotel, online purchase, airline, etc.), a time of transaction, a date of transaction, a mode of transaction authentication, a mode of transaction, transaction location information, network connectivity data, device data, user account data, and/or other attributes. The proxy transaction history 233 can further include a proxy transaction table 324 (FIG. 3E) that includes a unified summary of the transactions and transaction amounts applied to each member payment account. In various examples, the transaction table 324 can be presented to the group members 121 via a user interface 215 to allow the group members 121 to review. In some examples, the transaction table 324 can include a listing of all transactions and transaction amounts applied to a respective member payment account for each member 121. In other examples, the transaction table 324 can include a listing of all transactions and transaction amounts applied to the member payment account for a specific member 121.

The network content data 244 includes various data employed by the proxy account management service 209 and/or other type of application in generating user interfaces 215, and/or other network pages. It should be noted that although the examples of the present disclosure are directed towards the network content data 244 that is provided by the proxy account management service 209, the network content data 244 can be generated by any type of application that serves up network pages such as, for example, web pages and/or other types of network content to client devices 203. The network content data 244 can include hypertext markup language (HTML), extensible markup language (XML), cascading style sheets (CSS), images, text, audio, video, templates, and/or other data.

The transaction terminal 103 can be representative of a plurality of computing devices that can be coupled to the network 206. The transaction terminal 103 can include a corresponding computer system or computing device with a processor and a memory. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), a payment terminal, a point of sale (POS) system, or other devices with like capability.

Various applications or other functionality can be executed by the transaction terminal 103 according to various embodiments. The components executed on a transaction terminal 103 can include a transaction terminal service 250 and other applications, services, processes, systems, engines, or functionality not discussed in detail herein.

The transaction terminal service 250 can communicate with an issuer system 109 to conduct transactions with payment instruments associated with accounts of users or entities with an issuer. The transaction terminal service 250 can also communicate with client devices 203 to conduct transactions with payment instruments 100 that are presented to the transaction terminal service 250 during the initiation of a transaction. The transaction terminal service 250 can determine whether a particular transaction is approved or denied based upon information presented by a client device 203 and potentially other information, such as a transaction authorization notification 118 obtained from the issuer system 109.

The client device 203 is representative of a plurality of client devices that can be coupled to the network 206. The client device 203 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 203 can include one or more displays 253, such as liquid crystal displays (LCDs), gas plasma-based flat panel displays, organic light emitting diode (OLED) displays, electrophoretic ink (“E-ink”) displays, projectors, or other types of display devices. In some instances, the display 253 can be a component of the client device 203 or can be connected to the client device 203 through a wired or wireless connection.

The client device 203 can be configured to execute various applications such as a client application 256, a digital wallet 236, or other applications. The client application 256 can be executed in a client device 203 to access network content served up by the issuer system 109 or other servers, thereby rendering a user interface 215 on the display 253. To this end, the client application 256 can include a browser, a dedicated application, or other executable, and the user interface 215 can include a network page, an application screen, or other user mechanism for obtaining user input. The digital wallet 236 can be executed to communicate with the transaction terminal 103 and other systems to initiate payments with a transaction terminal 103. The client device 203 can be configured to execute applications beyond the client application 256 and the digital wallet 236 such as email applications, social networking applications, word processors, spreadsheets, or other applications.

Next, a general description of the operation of the various components of the network environment 200 is provided with respect to FIGS. 3A-7. To begin, FIGS. 3A-3E illustrate example user interfaces 215 (e.g., 215a, 215b, 215c, 215d, 215e) that can be rendered by a client device 203 interacting with the proxy account management service 209 with respect to the creation and management of a proxy transaction account and proxy transaction account group.

FIG. 3A illustrates an example user interface 215a generated by the proxy account management service 209 and rendered on a client device 203. The user interface 215a of FIG. 3A includes a list of groups 303 that include the interacting user as a member 121. As shown in FIG. 3A, the list of groups 303 includes “Vegas Trip,” “Work Party,” and “Home.” Accordingly, the user interacting with the user interface 215a has registered to be a member 121 of each respective group (e.g., as a creator or as an invited member) to allow for the sharing of expenses among group members 121 for each respective group. In particular, the user has previously provided payment account data for each group registration to allow his or her payment account to be used for shared expenses when a proxy transaction account is used for transactions in accordance to the respective proxy account rules 218.

FIG. 3A further includes a create group component 306 that, upon selection by a user, initiates the process to create a new proxy transaction account group. FIG. 3B illustrates an example of a user interface 215b that can be rendered on a client device 203 in response to a user requesting the creation of a new group (e.g., by selection of the create group component 306). The user interface 215b of FIG. 3B includes various user interface components that allow for the intake of proxy account data 224 for the group to be created. For example, the user interface 215b includes a group name component 309 that allows for the user (e.g., lead member 121) to enter the name of the group (e.g., “Beach Trip”). In addition, the user interface 215b includes an invitee component 312 that allows the user to input the invitee contact information for the invited members. In various examples, the invitee component 312 can comprise a text entry component or other type of user interface component that allows the user to input the one or more invited member's names, email addresses, phone numbers, and/or other data that can be used to identify and contact the respective members 121.

The user interface 215b of FIG. 3B further includes a split component 315 and a rewards component 318. Accordingly, the user can define at least a portion of the proxy account rules 218 by selecting the split component 315 or the rewards component 318. For example, selection of the split component 315 indicates that the transaction amount 112 is to be split and applied to the corresponding payment accounts of each member in the group. Although the split component 315 of FIG. 3B indicates that the split is going to be equal, in various examples, the user can define a non-equal ratio in which the transaction amount 112 is to be divided among the users. For example, in some situations, the lead member 121 may be responsible for 50% of the expenses while the remaining two members 121 are each responsible for only 25% of the expenses.

A user selection of the rewards component 318 indicates that the transaction amount 112 is to be applied to the payment account that maximizes the available rewards available based at least in part on a respective transaction. For example, a payment account for Member A may provide a $10 cashback offer based on the merchant associated with the transaction and the transaction amount 112 associated with the transaction while none of the other payment accounts for the remaining members offer a reward. As such, instead of splitting the transaction amount 112 across the payment accounts of all the members 121, the transaction amount 112 will be applied to the payment account for Member A in order to maximize the rewards offer associated with the transaction.

Although not illustrated in the user interface 215b of FIG. 3B, additional proxy account rules 218 can be defined by a lead member 121 and/or other registered members 121 via interactions with one or more user interfaces 215 associated with the proxy account management service 209. For example, some of the proxy account rules 218 can include an expiration date associated with the proxy transaction account (e.g., an end date of the event), a maximum transaction amount for all transactions, a maximum amount for individual transactions, permitted merchants, excluded merchants, permitted merchant types (e.g., restaurants, airlines, hotels, etc.), permitted merchant locations, and/or other types of rules which can be provided by a user interacting with one or more user interfaces 215 of the proxy account management service 209.

FIG. 3C illustrates an example user interface 215c that can be rendered on a client device 203 to allow a member 121 to input payment account data associated with a payment account that the member 121 wishes to be used for a given proxy transaction account group. The user interface 215c can be presented to the lead member 121 during the creation of the group and can be presented to members 121 who have accepted an invitation request to join the group being created. According to various examples, the user interface 215c can include user interface components that allow the user to input a payment account number 115, an account name, an expiration date, a card security code, an account address, and/or other data associated with the payment account provided by the user.

FIG. 3D illustrates an example user interface 215d that is rendered on a client device 203 in response to a proxy transaction group being created by a user. The example user interface 215d includes an indication that the group “Beach Trip” has been created and allows the user to manage his or her proxy account groups by selecting the manage group component 321. Upon selecting the manage group component 321, a user can be redirected to the user interface 215e of FIG. 3E.

FIG. 3E illustrates an example user interface 215e that is rendered on a client device 203 to provide transaction information associated with transactions using the proxy transaction account. The user interface 215e includes a proxy transaction table 324 that identifies the transactions associated with the proxy transaction account and the respective split amount 124 applied to the member payment account of the user interacting with the proxy account management service 209. Accordingly, the user is able to review all transactions applied to his or her member payment account with respect to transactions made using the proxy transaction account.

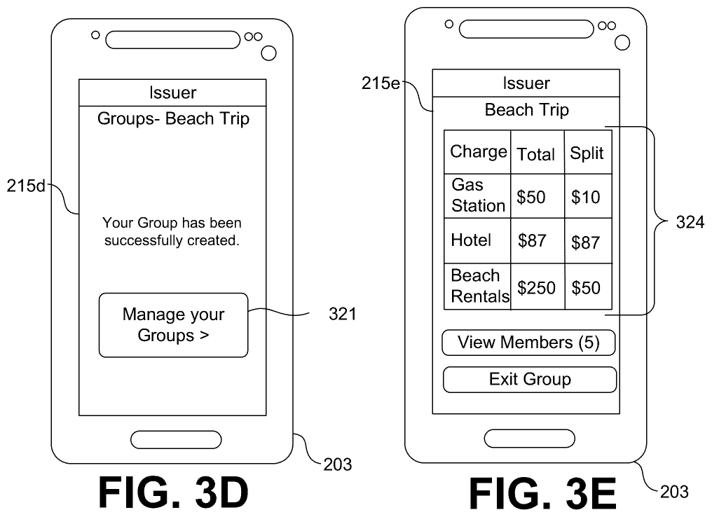

Referring next to FIG. 4, shown is a flowchart that provides one example of the operation of a portion of the proxy account management service 209. The flowchart of FIG. 4 provides merely an example of the many different types of functional arrangements that can be employed to implement the operation of the depicted portion of the of the proxy account management service 209. As an alternative, the flowchart of FIG. 4 can be viewed as depicting an example of elements of a method implemented within the network environment 200.

Beginning with block 403, the proxy account management service 209 receives a request to generate a proxy transaction group account. For example, a user interacting with a user interface 215 associated with the proxy account management service 209 can trigger the request to generate the proxy transaction group account via interaction with a user interface 215. In various examples, the request can include a group name, payment account data associated with the group creator (e.g., lead member 121), invitee contact information, one or more proxy account rules 218, and/or other data. In some examples, at least a portion of this information is included with the request. In other examples, at least a portion of this information is obtained by the proxy account management service 209 following receipt of an initial request.

At block 406, the proxy account management service 209 generates and sends an invitation to join the proxy transaction account group to the members 121 identified by the lead member 121 requesting creation of the group. In various examples, the invitation can include a link to access one or more user interfaces 215 generated by the proxy account management service 209 to provide the invited member 121 the ability to register with the proxy account management service 209 and/or input his or her member payment account data, including payment instrument data 221. The proxy account management service 209 can send the invitation to the invited members 121 based at least in part on the member contact data provided by the group creator. For example, the member contact data can include email addresses for each of the members being invited to the group and the invitation can comprise an email message that is sent to each email address of the members 121. In other examples, the member contact data can include a phone number and the invitation can comprise a short messaging service (SMS) message that is sent to each of the phone numbers of the members 121.

At block 409, the proxy account management service 209 determines whether at least one of the invited members 121 has accepted the invitation to join the group. For example, the invitation to join the group can comprise a selectable link, that when selected, directs the invited members associated with the invitation to one or more user interfaces 215 associated with the proxy account management service 209. The one or more user interfaces 215 can facilitate the registration of the member 121 and acceptance of the member 121 to join the group. In registering with the proxy account management service 209 and/or accepting the group invitation, the invited member 121 is asked to provide member transaction account data associated with a payment account that the user wishes to be associated with the proxy transaction account group. If the proxy account management service 209 determines that at least one of the invited members 121 has accepted the invitation to join the group, the proxy account management service 209 proceeds to block 412. Otherwise, the proxy account management service 209 continues to wait for an invited member 121 to join the group.

At block 412, the proxy account management service 209 generates the proxy transaction account for the proxy transaction account group. In particular, the proxy account management service 209 can generate the account number 115 to be associated with the proxy transaction account. The account number 115 corresponds to an issuer assigned account number to represent the proxy transaction account. The issuer assigned account number is a unique number that is used to identify an issuer associated with the account and a payment account provided by the issuer. In addition, the proxy account management service 209 generates proxy account data 224 that is associated with a particular proxy group created via the proxy account management service 209. The proxy account data 224 can include a group name, a group lead member identifier, an account number 115, group member data 230, proxy account rules 218, proxy transaction history 233, and/or other data.

At block 415, the proxy account management service 209 provides the proxy account number 115 and any other relative proxy account data 224 to the client device 203 associated with the lead member 121 of the proxy transaction account group. In particular, the proxy account number 115 is sent to the client device 203 over the network 206 for storage in the digital wallet 236 (e.g., GOOGLE PAY® APPLE PAY®, etc.) for immediate or future use.

At block 418, the proxy account management service 209 initiates the creation of and mailing of a physical payment card for the proxy transaction account. In various examples, the physical payment card is mailed to the lead member 121 of the group and/or other members 121 of the group. In other examples, one or more members 121 may be provided a payment account number, a cardholder name, an expiration date, a verification code, a billing address, and/or other information needed to consummate a payment. This information can be provided to the members 121 electronically, over the phone, and/or through the mail. Thereafter, this portion of the process proceeds to completion.

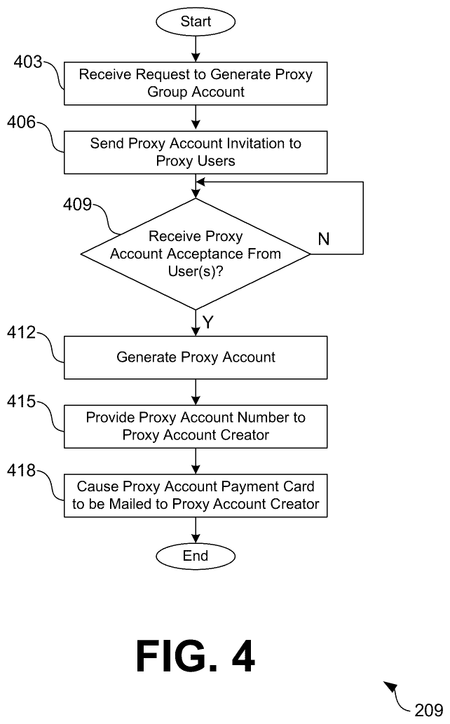

Referring next to FIG. 5, shown is a flowchart that provides one example of the operation of a portion of the issuer service 212. The flowchart of FIG. 5 provides merely an example of the many different types of functional arrangements that can be employed to implement the operation of the depicted portion of the issuer service 212. As an alternative, the flowchart of FIG. 5 can be viewed as depicting an example of elements of a method implemented within the network environment 200.

Beginning with block 503, the issuer service 212 receives a transaction authorization request 106 from a transaction terminal service 250 of the transaction terminal 103 associated with a merchant. In particular, a payment instrument 100 associated with a proxy transaction account is presented at a transaction terminal 103 during a transaction for goods or services provided by a merchant. When the payment instrument 100 associated with the proxy transaction account is presented to a transaction terminal 103 for the purchase of goods or services, the transaction terminal 103 generates and sends the transaction authorization request 106 to the issuer service 212 of the issuer system 109 associated with the payment instrument 100. The transaction authorization request 106 can comprise a transaction amount 112, payment instrument data (e.g., an account number 115, an account name, a verification code, etc.), a merchant identifier, and/or other type of transaction data.

At block 506, the issuer service 212 determines whether the transaction is valid. In various examples, the issuer service 212 can confirm that funds or credit are available for the payment instruments 100 of the member payment accounts that are mapped to the proxy transaction account to determine whether the payment transaction account is authorized to proceed or not authorized to proceed. In various examples, the issuer system 109 can determine that the transaction amount 112 is within an approved budget associated with the proxy transaction group as defined by the proxy account rules 218. For example, the proxy account rules 218 can indicate a maximum amount of funds to be charged with a given transaction and/or over all transactions. If the transaction amount 112 included in the transaction data of the transaction authorization request 106 exceeds the maximum amount of funds defined by the proxy account rules 218, the issuer service 212 can deny the transaction authorization request 106. If the issuer service 212 determines that the transaction authorization request 106 is not valid, the issuer service 212 proceeds to block 509. Otherwise, the issuer service proceeds to block 512.

At block 509, the issuer service 212 generates an authorization notification 118 indicating that the transaction is denied. The issuer service 212 can send the authorization notification 118 to the transaction terminal service 250 which can then proceed with terminating the transaction and corresponding request. Thereafter, this portion of the process proceeds to completion.

At block 512, the issuer service 212 generates an authorization notification 118 indicating that the transaction is approved. The issuer service 212 can send the authorization notification 118 to the transaction terminal service 250 which can then proceed with authorizing the transaction and allowing the transaction to complete. Thereafter, this portion of the process proceeds to completion.

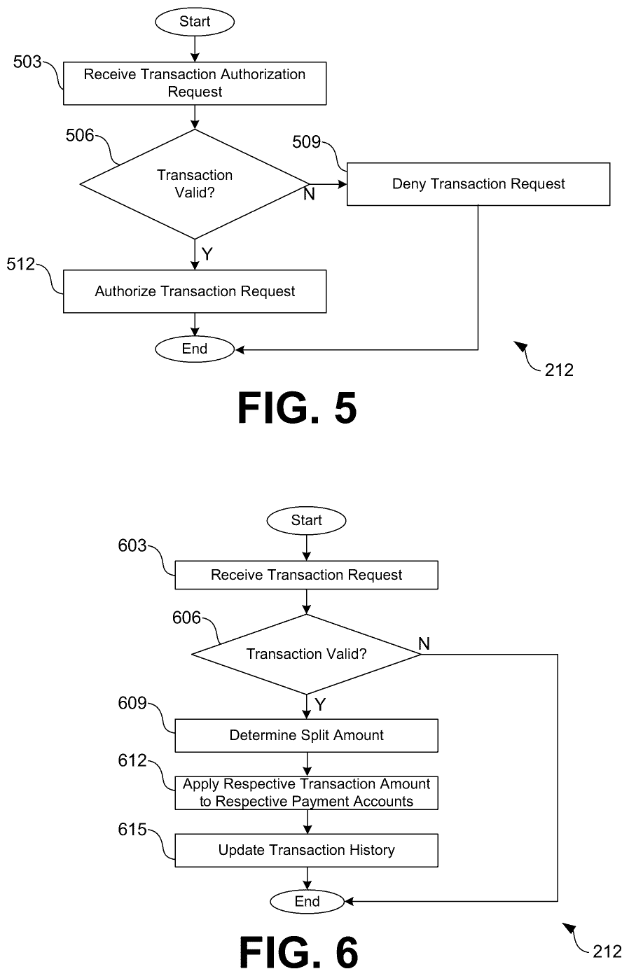

Referring next to FIG. 6, shown is a flowchart that provides one example of the operation of a portion of the issuer service 212. The flowchart of FIG. 6 provides merely an example of the many different types of functional arrangements that can be employed to implement the operation of the depicted portion of the issuer service 212. As an alternative, the flowchart of FIG. 6 can be viewed as depicting an example of elements of a method implemented within the network environment 200.

Beginning with block 603, the issuer service 212 receives a transaction authorization request 106 from a transaction terminal service 250 of the transaction terminal 103 associated with a merchant. In particular, a payment instrument 100 associated with a proxy transaction account is presented at a transaction terminal 103 during a transaction for goods or services provided by a merchant. When the payment instrument 100 associated with the proxy transaction account is presented to a transaction terminal 103 for the purchase of goods or services, the transaction terminal 103 generates and sends the transaction authorization request 106 to the issuer service 212 of the issuer system 109 associated with the payment instrument 100. The transaction authorization request 106 can comprise a transaction amount 112, payment instrument data (e.g., an account number 115, an account name, a verification code, etc.), a merchant identifier, and/or other type of transaction data.

At block 606, the issuer service 212 determines whether the transaction is valid. In various examples, the issuer service 212 can confirm that funds or credit are available for the payment instruments 100 of the member payment accounts that are mapped to the proxy transaction account to determine whether the payment transaction account is authorized to proceed or not authorized to proceed. In various examples, the issuer system 109 can determine that the transaction amount 112 is within an approved budget associated with the proxy transaction group as defined by the proxy account rules 218. For example, the proxy account rules 218 can indicate a maximum amount of funds to be charged with a given transaction and/or over all transactions. If the transaction amount 112 included in the transaction data of the transaction authorization request 106 exceeds the maximum amount of funds defined by the proxy account rules 218, the issuer service 212 can deny the transaction authorization request 106. If the issuer service 212 determines that the transaction authorization request 106 is valid, the issuer service 212 proceeds to block 609. Otherwise, the issuer service 212 denies the transaction and this portion of the process proceeds to completion.

At block 609, the issuer service 212 determines that the transaction amount 112 associated with the transaction is to be split among the member payment accounts of the group members 121 of the proxy transaction account group and determines the respective split amount 124 to be applied to each member payment account. For example, the proxy account rules 218 can indicate how the transaction amount 112 is to be split among the members 121 of the group. In some examples, the transaction amount 112 is split equally among the group members. In other examples, the transaction amount 112 is split according to a predefined percentage or ratio for each member of the group. In the example of FIG. 1, the transaction amount 112 of $500 is split equally among the four group members 121 such that the respective split amount 124 is $125, which corresponds to the amount that each member 121 is responsible for with regard to the given transaction.

At block 612, the issuer service 212 applies the respective split amount 124 to each member payment account of the members 121 of the group. For example, during registration and acceptance to be a member 121 in the group, each member provided payment instrument data 221 corresponding to data associated with payment accounts provided by an issuer associated with of the issuer system 109. For example, the payment instrument data 221 can comprise data describing credit card accounts, debit card accounts, virtual cards, charge card accounts, and/or other mechanisms for effecting a payment with respect to a transaction account provided by the issuer of the issuer system 109. Accordingly, the issuer service 212 applies the respective split amount 124 to each payment instrument such that each member's respective payment account is deducted by the respective split amount 124.

At block 615, the issuer service 212 updates the proxy transaction history 233 and corresponding transaction table 324 to reflect the transaction and responsible expense (e.g., the respective split amount 124) for each member 121. In various examples, the proxy transaction history 233 includes a transaction amount 112, a transaction merchant, industry identification data associated with the transaction (e.g., fast food restaurant, hotel, online purchase, airline, etc.), a time of transaction, a date of transaction, a mode of transaction authentication, a mode of transaction, transaction location information, network connectivity data, device data, user account data, and/or other attributes. The proxy transaction table 324 can include a unified summary of the transactions and transaction amounts applied to each member payment account. In some examples, the transaction table 324 can include a listing of all transactions and transaction amounts applied to a respective member payment account for each member 121. In other examples, the transaction table 324 can include a listing of all transaction and transaction amounts applied to the member payment account for a specific member 121. The proxy transaction history 233 and the transaction table 324 are updated by the issuer service 212 to include the currently pending transaction. Thereafter, this portion of the process proceeds to completion.

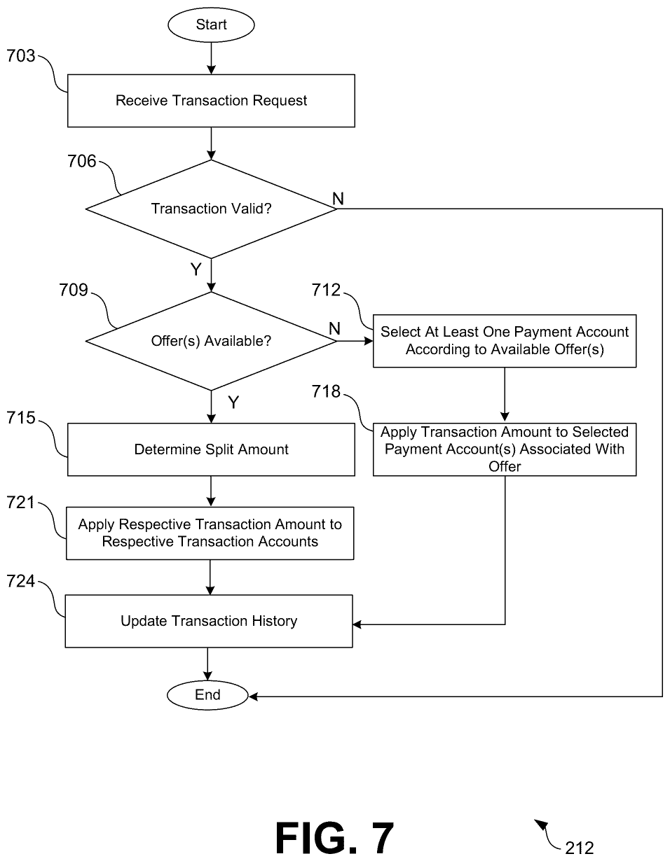

Referring next to FIG. 7, shown is a flowchart that provides one example of the operation of a portion of the issuer service 212. The flowchart of FIG. 7 provides merely an example of the many different types of functional arrangements that can be employed to implement the operation of the depicted portion of the issuer service 212. As an alternative, the flowchart of FIG. 7 can be viewed as depicting an example of elements of a method implemented within the network environment 200.

Beginning with block 703, the issuer service 212 receives a transaction authorization request 106 from a transaction terminal service 250 of the transaction terminal 103 associated with a merchant. In particular, a payment instrument 100 associated with a proxy transaction account is presented at a transaction terminal 103 during a transaction for goods or services provided by a merchant. When the payment instrument 100 associated with the proxy transaction account is presented to a transaction terminal 103 for the purchase of goods or services, the transaction terminal 103 generates and sends the transaction authorization request 106 to the issuer service 212 of the issuer system 109 associated with the payment instrument 100. The transaction authorization request 106 can comprise a transaction amount 112, payment instrument data (e.g., an account number 115, an account name, a verification code, etc.), a merchant identifier, and/or other type of transaction data.

At block 706, the issuer service 212 determines whether the transaction is valid. In various examples, the issuer service 212 can confirm that funds or credit are available for the payment instruments 100 of the member payment accounts that are mapped to the proxy transaction account to determine whether the payment transaction account is authorized to proceed or not authorized to proceed. In various examples, the issuer system 109 can determine that the transaction amount 112 is within an approved budget associated with the proxy transaction group as defined by the proxy account rules 218. For example, the proxy account rules 218 can indicate a maximum amount of funds to be charged with a given transaction and/or over all transactions. If the transaction amount 112 included in the transaction data of the transaction authorization request 106 exceeds the maximum amount of funds defined by the proxy account rules, 218, the issuer service 212 can deny the transaction authorization request 106. If the issuer service 212 determines that the transaction authorization request 106 is valid, the issuer service 212 proceeds to block 709. Otherwise, the issuer service 212 denies the transaction and this portion of the process proceeds to completion.

At block 709, the issuer service 212 determines that reward offers are to be maximized for the proxy account group and determines whether there are any offers available based at least in part on the transaction data associated with the transaction and the offer data 247 included in the payment instrument data 221 corresponding to the member payment accounts of the group member 121. The offer data 247 can identify one or more offers that can be earned by using the respective payment instrument 100 for a given transaction. The one or more offers can include an award of loyalty points, a rebate amount, a discount for the items being purchased, a reward currency, a loyalty currency, and/or the like. In various examples, each offer can have offer criteria which define various factors that must be met in order for the respective offer to be earned. For example, the offer criteria can define a merchant, a merchant type, a transaction amount, a type of transaction (e.g., online vs. brick and mortar), a location of the transaction, a time or date associated with the transaction and/or other factors that may need to be met for a given transaction in order to earn the respective offer and/or reward. If there are available offers associated with the transaction and at least one payment account, the issuer service 212 proceeds to block 712. Otherwise, the issuer service 212 proceeds to block 715.

At block 712, the issuer service 212 selects at least one payment account from the plurality of payment accounts associated with the group members 121. For example, the issuer service 212 can generate a score associated with each available offer based at least in part on what is included with each offer. In particular, offers can include an award of loyalty points, a rebate amount, a discount for the items being purchased, a reward currency, a loyalty currency, and/or the like. An offer score for each available offer can be generated based at least in part on a sum of respective weights to each feature of the offer. For example, if one payment account provides a $10 rebate and a second payment account provides a $20 rebate, the offer associated with the second payment account may be given a higher score due to the rebate amount being greater than that of the first payment account. In some examples, multiple payment accounts can include the same offer and can each be selected together.

At block 718, the issuer service 212 applies the transaction amount 112 of the transaction to only the selected payment account(s) associated with the offer. If there are multiple payment accounts that include the same offer, the issuer service 212 can apply a portion of the transaction amount 112 to each of the selected payment accounts. The portion of the respective transaction amount 112 can be equal or based on a predefined ratio or percentage.

At block 715, the issuer service 212 determines the respective split amount 124 to be applied to each member payment account. For example, the proxy account rules 218 can indicate how the transaction amount 112 is to be split among the members 121 of the group. In some examples, the transaction amount 112 is split equally among the group members. In other examples, the transaction amount 112 is split according to a predefined percentage or ratio for each member of the group. In the example of FIG. 1, the transaction amount 112 of $500 is split equally among the four group members 121 such that the respective split amount 124 is $125, which corresponds to the amount that each member is responsible for with regard to the given transaction. In examples where one payment account may have been charged the full transaction amount 112 of a prior transaction based at least in part on an available offer, the issuer service 212 can automatically reconcile the amount owed by each member 121 and determine to apply nothing to the payment account used for an entire payment to compensate for the extra amount previously deducted.

At block 721, the issuer service 212 applies the respective split amount 124 to each member payment account of the members 121 of the group. For example, during registration and acceptance to be a member 121 in the group, each member provided payment instrument data 221 corresponding to data associated with payment accounts provided by an issuer associated with of the issuer system 109. For example, the payment instrument data 221 can comprise data describing credit card accounts, debit card accounts, virtual cards, charge card accounts, and/or other mechanisms for effecting a payment with respect to a transaction account provided by the issuer of the issuer system 109. Accordingly, the issuer service 212 applies the respective split amount 124 to each payment instrument such that each member's respective payment account is deducted by the respective split amount 124.

At block 724, the issuer service 212 updates the proxy transaction history 233 and corresponding transaction table 324 to reflect the transaction and responsible expense (e.g., the respective split amount 124 or total transaction amount 112) for each member 121. In various examples, the proxy transaction history 233 includes a transaction amount 112, a transaction merchant, industry identification data associated with the transaction (e.g., fast food restaurant, hotel, online purchase, airline, etc.), a time of transaction, a date of transaction, a mode of transaction authentication, a mode of transaction, transaction location information, network connectivity data, device data, user account data, and/or other attributes. The proxy transaction table 324 can include a unified summary of the transactions and transaction amounts 112 applied to each member payment account. In some examples, the transaction table 324 can include a listing of all transactions and transaction amounts applied to a respective member payment account for each member 121. In other examples, the transaction table can include a listing of all transaction and transaction amounts applied to the member payment account for a specific member 121. The proxy transaction history 233 and the transaction table 324 are updated by the issuer service 212 to include the currently pending transaction. Thereafter, this portion of the process proceeds to completion.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same issuer system 109.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive a transaction authorization request associated with a transaction, the transaction authorization request comprising a transaction amount and a proxy account number, and the proxy account number representing a proxy for a plurality of transaction accounts of a plurality of users;
determine that the transaction is valid based at least in part on the transaction amount and proxy account rules associated with the proxy account number;
authorize the transaction;
select at least one transaction account from the plurality of transaction accounts; and
deduct the transaction amount from the at least one transaction account.

2. The system of claim 1, wherein the machine-readable instructions further cause the computing device to at least:
identify a plurality of reward offers available for the transaction based at least in part on offer data associated with the plurality of transaction account; and
rank the plurality of reward offers, the at least one transaction account being selected based at least in part on a highest ranked reward offer of the plurality of reward offers.

3. The system of claim 2, wherein the plurality of reward offers are ranked in order to maximize the plurality of reward offers associated with the plurality of transaction accounts.

4. The system of claim 1, wherein the proxy account number is mapped to the plurality of transaction accounts and the machine-readable instructions further cause the computing device to at least:
confirm that the transaction amount of the transaction satisfies a credit or fund availability of individual transaction accounts associated with the plurality of transaction accounts mapped to the proxy account number.

5. The system of claim 1, wherein the machine-readable instructions further cause the computing device to at least generate a proxy account for a shared transaction group, the proxy account comprising the proxy account number, group member data, proxy account rules, proxy transaction history, and a proxy group name.

6. The system of claim 1, wherein the machine-readable instructions further cause the computing device to at least:
obtain a proxy group creation request via one or more user interactions with a user interface rendered on a client device associated with a user, the proxy group creation request requesting a creation of a proxy transaction account and identifying a plurality of members of a shared transaction group;
obtain the plurality of transaction account numbers from the plurality of members; and
map the proxy account number to the plurality of transaction account numbers.

7. The system of claim 1, wherein the machine-readable instructions further cause the computing device to at least:
invoke a fraud detection service to predict whether the transaction is fraudulent, the transaction being authorized based at least in part on a prediction from the fraud detection service.

8. A method, comprising:
receiving a transaction authorization request associated with a transaction, the transaction authorization request comprising a transaction amount and a proxy account number, and the proxy account number representing a proxy for a plurality of transaction accounts of a plurality of users;
determining that the transaction is valid based at least in part on the transaction amount and proxy account rules associated with the proxy account number;
authorizing the transaction;
selecting at least one transaction account from the plurality of transaction accounts; and
deducting the transaction amount from the at least one transaction account.

9. The method of claim 8, further comprising:
identifying a plurality of reward offers available for the transaction based at least in part on offer data associated with the plurality of transaction account; and
ranking the plurality of reward offers, the at least one transaction account being selected based at least in part on a highest ranked reward offer of the plurality of reward offers.

10. The method of claim 9, wherein the plurality of reward offers are ranked in order to maximize the plurality of reward offers associated with the plurality of transaction accounts.

11. The method of claim 8, wherein the proxy account number is mapped to the plurality of transaction accounts and further comprising:
confirming that the transaction amount of the transaction satisfies a credit or fund availability of individual transaction accounts associated with the plurality of transaction accounts mapped to the proxy account number.

12. The method of claim 8, further comprising generating a proxy account for a shared transaction group, the proxy account comprising the proxy account number, group member data, proxy account rules, proxy transaction history, and a proxy group name.

13. The method of claim 8, further comprising:
obtaining a proxy group creation request via one or more user interactions with a user interface rendered on a client device associated with a user, the proxy group creation request requesting a creation of a proxy transaction account and identifying a plurality of members of a shared transaction group;
obtaining the plurality of transaction account numbers from the plurality of members; and
mapping the proxy account number to the plurality of transaction account numbers.

14. The method of claim 8, further comprising invoking a fraud detection service to predict whether the transaction is fraudulent, the transaction being authorized based at least in part on a prediction from the fraud detection service.

15. A non-transitory, computer-readable medium, comprising machine-readable instructions that, when executed by a processor of a computing device, cause the computing device to at least:
receive a transaction authorization request associated with a transaction, the transaction authorization request comprising a transaction amount and a proxy account number, and the proxy account number representing a proxy for a plurality of transaction accounts of a plurality of users;
determine that the transaction is valid based at least in part on the transaction amount and proxy account rules associated with the proxy account number;
authorize the transaction;
select at least one transaction account from the plurality of transaction accounts; and
deduct the transaction amount from the at least one transaction account.

16. The non-transitory, computer-readable medium of claim 15, wherein the machine-readable instructions further cause the computing device to at least:
identify a plurality of reward offers available for the transaction based at least in part on offer data associated with the plurality of transaction account; and
rank the plurality of reward offers, the at least one transaction account being selected based at least in part on a highest ranked reward offer of the plurality of reward offers.

17. The non-transitory, computer-readable medium of claim 16, wherein the plurality of reward offers are ranked in order to maximize the plurality of reward offers associated with the plurality of transaction accounts.

18. The non-transitory, computer-readable medium of claim 15, wherein the proxy account number is mapped to the plurality of transaction accounts and the machine-readable instructions further cause the computing device to at least:
confirm that the transaction amount of the transaction satisfies a credit or fund availability of individual transaction accounts associated with the plurality of transaction accounts mapped to the proxy account number.

19. The non-transitory, computer-readable medium of claim 15, wherein the machine-readable instructions further cause the computing device to at least generate a proxy account for a shared transaction group, the proxy account comprising the proxy account number, group member data, proxy account rules, proxy transaction history, and a proxy group name.

20. The non-transitory, computer-readable medium of claim 15, wherein the machine-readable instructions further cause the computing device to at least:
invoke a fraud detection service to predict whether the transaction is fraudulent, the transaction being authorized based at least in part on a prediction from the fraud detection service.
